(19) United States
(12) Patent Application Publication
(10) Pub. No.: US 2007/0032397 A1
(43) Pub. Date: Feb. 8, 2007

(54) Fragrant monopersulfate compositions for water treatment and articles containing them

(76) Inventors: Richard T. Coffey, Pompano Beach, FL (US); Robert Harnden, Tamarac, FL (US); Heather A. Poetz, Davie, FL (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/196,082

(22) Filed: Aug. 3, 2005

(51) Int. Cl. C11D 3/00

(52) U.S. Cl. 510/367

(57) ABSTRACT

The invention relates to fragrant compositions for oxidizing organic compounds in pool or spa water, having an alkali metal monopersulfate, a fragrance, and an optional carrier, which do not have a multilayer tablet structure and which do not generate gas, fumes or significant heat on addition to water.

### BACKGROUND OF THE INVENTION

1. Field of the Invention

The invention relates to compositions and methods for treating water, in particular pool and spa water, with a composition comprising monopersulfate, fragrance, and an optional carrier.

2. Description of Related Art

Purification and sanitization of bodies of water, and in particular pool and spa water, is typically accomplished by adding chemical sanitizing agents, such as hypohalite salts, by electrolytic purification, whereby hypohalites are formed in situ in an electrolyzer, by addition of metal ions, such as silver and/or copper, or by some combination of these techniques. These sanitization techniques reduce the load of bacteria and other microorganisms in the water by directly killing the organisms. A similar approach is taken to reduce algae in water, often by adding metals or salts of metals, such as copper, which directly kill algae that might otherwise grow in the water.

Another approach to keeping pool water clean and sanitary, often used in parallel with the chemical and/or electrolytic sanitizing techniques described above, is to treat the water to remove organic materials, often generated by bathers using the water, that can combine with the sanitizing chemicals to produce odor forming materials, typically chloramines and trihalomethanes. These chemicals can also produce water turbidity, irritation of skin and eyes, and other unpleasant effects. This treatment, known as “shocking” the water, typically involves the addition of a quantity of strong oxidizing agent to break down organic waste chemicals in the pool. The use of alkali metal salts of monopersulfate, such as sodium monopersulfate or potassium monopersulfate, as a shocking agent to oxidize organic materials in the water, is described in U.S. Pat. No. 6,824,794.

However, use of monopersulfate shocking agents take time to reduce the odor-causing organic materials in the water. It would be desirable to, in the interim, mask that odor with a fragrance that can be introduced into the water along with the monopersulfate. Compositions for such use have been suggested by DuPont; these compositions combine, in a powdered or particulate form, monopersulfate with fragrance disposed on a sodium carbonate carrier. However, these compositions are not commercially acceptable because, when introduced into water, the compositions generate large amounts of gas and heat, believed by the inventors of this application to be the result of an exothermic acid-base reaction that generates carbon dioxide. The monopersulfate is a triple salt (2KHSO₃.KHSO₄.K₂SO₄) that dissociates in water to yield acid. The acid produced is capable of reacting with carbonate ion present from the carrier material according to the reaction:
2KHSO₅.KHSO₄.K₂SO₄→K⁺+HSO₅⁻+K⁺+HSO₄⁻+K⁺+SO₄²⁻
2HSO₄⁻+CO₃²⁻→2SO₄²⁻+CO₂↑+H₂O

DuPont has also suggested that its OXONE® monopersulfate product can be combined with a wide variety of additives, including “sodium sulfate, sodium carbonate (especially dense), sodium bicarbonate, sodium sesquicarbonate, sodium perborate (monohydrate or anhydrous, but not tetrahydrate), tetrasodium pyrophosphate, sodium tripolyphosphate, sodium metasilicate; citric, malic, and tartaric acids, wetting agents and detergents, and fragrances. All ingredients used with Oxone® should be anhydrous or should hold hydrated water tightly; stability testing of each blend is essential. Since Oxone® is acidic, it is usually blended with sufficient alkaline salts to buffer it to near-neutral or slightly alkaline pH when compounded into cleaners. Formulations of Oxone® containing chloride ions can be used to generate low concentrations of active chlorine in cleaning systems, provided the blend is pH buffered to avoid evolution of chlorine gas, and special care is taken to exclude moisture from the formulation; bromides and iodides are more reactive and generally should not be blended with Oxone®.”

http://www.dupont.com/oxone/techinfo/#processing (1998)

However, DuPont failed to recognize that all of the carrier materials recited are not equivalent when a fragrance material is introduced into the composition, that sodium carbonate should be avoided in such compositions, that halide ion forming carriers, including chloride ion formers, should be avoided, or that organic polymeric materials could be included as carriers, all of which was discovered by the inventors of this application.

U.S. Pat. No. 6,863,830 discloses a multilayer tablet for treating pool water having a fast dissolving layer and a slow dissolving layer. The fast dissolving layer can contain a laundry list of different materials, including lithium hypochlorite, calcium hypochlorite, trichloroisocyanuric acid (TCCA), anhydrous sodium dichloroisocyanurate, sodium persulfate, potassium persulfate, potassium monopersulfate, sodium monopersulfate, and mixtures thereof, and at least one of a clarifier, chelating agent, sequesterant, algaestat, water softener, algaecide, corrosion inhibitor, scale inhibitor, flocculent, disintegrant, dispersant, colorant, dissolution control agent, fragrance, or surfactant. However, the tablet also requires the presence of a slow dissolving layer that includes a member selected from the group consisting of trichloroisocyanuric acid (TCCA), calcium hypochlorite, 1,3-dichloro-5,5-dimethylhydantoin (DCDMH), 1,3-dibromo-5,5-dimethyl hydantoin (DBDMH), 1-bromo-3-chloro-5,5-dimethylhydantoin (BCDMH), 1,3-dichloro-5-ethyl-5-methylhydantoin (DCEMH), 1,3-dibromo-5-ethyl-5-methylhydantoin (DBEMH), 1-bromo-3-chloro-5-methyl-5-ethylhydantoin (BCEMH), and mixtures thereof, and at least one of a clarifier, chelating agent, sequesterant, algaestat, water softener, algaecide, corrosion inhibitor, scale inhibitor, flocculent, disintegrant, dispersant, colorant, dissolution control agent or surfactant.

Such a multilayer structure is complex and expensive to manufacture, and is designed to release different halogen compositions into the water at different times. It would not be suitable or commercially acceptable as a product designed to simply provide a water shock treatment, as described above. Moreover, while the patent discloses including sodium carbonate as a possible component in the tablet, there is no specific disclosure of adding a fragrance, of a composition containing both monopersulfate and a fragrance, or any recognition of any problems associated with the presence of a fragrance or of monopersulfate together with sodium carbonate.

Accordingly, there remains a need in the art for a monopersulfate composition that can also provide a fragrance to the water to be treated, that does not adversely react with the fragrance composition, or generate fumes and heat upon addition to the water, and that does not require a complex, multilayer tablet structure.

### SUMMARY OF THE INVENTION

The composition of this invention avoids the problems associated with monopersulfate compositions using a sodium carbonate fragrance carrier. Unexpectedly, it has been found that the use of a separate carrier material for the fragrance is not necessary in order to have a functional product, and that the fragrance can be applied to the monopersulfate powder or granules directly; in effect, the monopersulfate acts as a carrier for the fragrance. This technique unexpectedly provides good fragrance quality to the water, even after ageing of the finished product. The resulting composition contains an amount of fragrance that approximates that applied to a sodium carbonate carrier. In addition, application of fragrance directly to monopersulfate gives a fragrance loss after ageing comparable to that obtained with a sodium carbonate carrier, but without the copious heat and fume generation associated with the use of a sodium carbonate carrier. Thus, one embodiment of the invention relates to compositions for use in treating pool and spa water comprising an alkali metal monopersulfate and a fragrance, in the absence of a carrier particle for the fragrance, and in the absence of any multilayer structure having a slow release layer.

In another embodiment of the invention, it has been found that judicious selection of carrier for the fragrance can provide a commercially acceptable water shock composition with alkali metal monopersulfates. In this regard, it has been discovered that both inorganic and organic carriers may be used, but that:
carbonate salts should be avoided, since the resulting acid-base reactions will generate heat and carbon dioxide;
halide salts should be avoided, since these tend to generate malodor and/or copious fumes (without wishing to be bound by theory, it is believed that the monopersulfate oxidizes the chloride ion in water, creating an oxidant that attacks the fragrance molecule);
sodium acetate should be avoided, since it generates malodor and copious fumes.

In this regard, the invention relates to a composition for oxidizing organic materials in water, comprising:

(a) an alkali metal monopersulfate;

(b) a fragrance;

wherein the composition is substantially free of carbonate, bicarbonate, and halide, salts, and wherein the composition does not contain a slow dissolving layer. The fragrance can be deposited or adhered to particles of the alkali metal monopersulfate, or the composition can additionally contain a water-soluble or water-dispersible particulate carrier for the fragrance

In another embodiment of the invention, it has been found that an alkaline earth metal sulfate, in particular magnesium sulfate, provides a suitable carrier material for the fragrance in combination with monopersulfate, and that this combination of components provides good fragrance quality, good fragrance loadings and stability to ageing, and no reactivity in pool or spa water.

In another embodiment of the invention, it has been found that organic polymeric materials, such as carboxymethylcellulose, hydroxypropylcellulose, polyacrylic acid, and copolyacrylic acid-acrylamide, are suitable fragrance carriers when combined with monopersulfates. They also provide good fragrance quality, good fragrance loadings and stability, and no reactivity in pool or spa water.

### DETAILED DESCRIPTION OF SPECIFIC EMBODIMENTS

As used herein, the term “slow dissolving layer” has the meaning given to it in U.S. Pat. No. 6,863,830, the entire contents of which is incorporated herein by reference. As used herein, the term “substantially free of” a material means that the material is not present in sufficient quantities to affect the oxidizing or fragrance characteristics or materially affect the performance of the composition in its intended use. As an example, a composition that is substantially free of carbonate salts would not contain sufficient amounts of any carbonate that would cause the generation of gas, fumes, or heat when the composition is added to water.

As described above, the oxidizing compositions of the invention contain at least two components: an alkali metal monopersulfate, and a fragrance. If the monopersulfate is itself to function as the carrier for the fragrance, no other components need be added, although those of ordinary skill in the art will recognize that other compositional components, such as clarifiers, chelating agents, surfactants, sequestrants, flocculants, etc., can be included, provided that they do not have a significant adverse effect on either the composition's oxidizing ability or the quality or stability of the fragrance.

If a carrier for the fragrance that is separate from the monopersulfate is to be used, then this carrier should be water-soluble or water-dispersible, and should not react in the presence of water and monopersulfate in a manner that generates gas, fumes, or heat, or in a manner that degrades (or forms reactive intermediates or products that degrade) the fragrance molecules. Materials that have been found to be suitable as carriers for the composition of the invention include water-soluble alkaline earth metal sulfate, a water-soluble alkali metal borate, a water-soluble or water-dispersible organic polymeric material, and combinations thereof. In particular, magnesium sulfate, sodium borate, carboxymethylcellulose, hydroxypropylcellulose, polyacrylic acid, co-polyacrylic acid-acrylamide, and mixtures or blends thereof, have been found to be particularly suitable carrier materials. These materials are water-soluble, so that the fragrance is released into the water quickly, and are not reactive in the presence of pool or spa water and monopersulfate. They also provide good fragrance quality, stability, and loading, as explained in more detail below.

The fragrance material used in the composition is not critical; any formulation that provides a pleasing fragrance to the water and is reasonably stable to typical pool and spa chemistry can be used. Typically the fragrance is applied as an essential oil, although solutions or dispersions of the fragrance oils in an organic solvent can also be used. Aqueous solutions or dispersions of fragrance are typically not desirable, as they tend to dissolve and/or degrade the carrier or monopersulfate.

The fragrance can be applied by spraying onto particles of the monopersulfate or carrier material using an atomizer, and allowing the particles to dry. If a carrier separate from the monopersulfate is used, the carrier particles are sprayed separately from the monpersulfate particles, allowed to dry, and then blended with the monopersulfate particles. If the composition is not to contain a carrier separate from the monopersulfate, then the fragrance is simply atomized onto the monopersulfate particles and allowed to dry. The amount of fragrance applied can generally range from about 0.5% to about 2.0%, more particularly from about 1.5% to about 2.0%, based on the weight of the fragrance and carrier or the weight of the fragrance and monopersulfate.

The following example and comparative example compositions were prepared to further illustrate the invention. The are not intended to limit the scope of the claims of this application.

In the examples and comparative examples, the compositions were prepared by using an atomizer which mixes a compressed gas with the fragrance to disperse a fragrance essential oil into fine droplets onto a bed of particles (either the carrier indicated below in Table 1, or monopersulfate, as indicated in Table 1). The initial percent mass of the fragrance for each example and comparative example is indicated in Table 1. Each composition was then dissolved in deionized water and isopropyl alcohol and evaluated for fragrance quality through measuring absorbance near 270 nm on a Hach DR 4000 spectrophotometer. The percent MPS (a measure of the oxidizing capacity of the material) was analyzed through use of a Mettler autotitrator which ran a simple iodometric titration to determine the equivalence point with a primary standard of sodium thiosulfate; and reactivity in spa water, each of which are reported in Table 1.

The fragrance blends were then subjected to an accelerated aging procedure in an Hotpack environmental chamber at 43 Celsius and 70% relative humidity for five days (except for Examples 5-8, which used an ageing time of 8.7 days, and Example 9, which used an ageing time of 4.5 days). The accelerated aging was determined to simulate natural aging for at least 1 year on the shelf at laboratory conditions. At the end of this period, the characteristics of the fragrance blends were re-evaluated, and the characteristics and percent change are reported in Table 1. Compositions that generated copious fumes prior to the accelerated aging were not evaluated further.

The fragrances used were “Aqua Fresh CE-70590,” obtained from Custom Essence, “Colada CE-71476,” obtained from Custom Essence, “Relax CE-717478,” obtained from Custom Essence, and “Peach,” obtained from Ronald T Dodge Company in microencapsulated form. As can be readily seen from Table 1, potassium monopersulfate with no carrier provided good fragrance quality before and after aging, as well as good fragrance loading, and good oxidizing power, both before and after ageing, as did magnesium sulfate, carboxymethylcellulose, hydroxypropylcellulose, polyacrylic acid, and co-polyacrylic acid-acrylamide. Sodium carbonate, by contrast, generated copious gas and heat on mixing with spa water. Magnesium chloride, sodium chloride, and sodium acetate all generated malodor and copious fumes during contact with the fragrance, and before introduced into spa water, and were therefore not evaluated further. Sodium borate and sodium bisulfate gave good fragrance quality before ageing, as well as good fragrance loading and oxidizing power, and acceptable fragrance stability. While some malodor was observed after ageing, these materials are still considered to be commercially acceptable carriers, since the ageing period was conservative, and longer than the recommended life of the product is expected to be.

In Example 9, the fragrance was introduced in the form of a microcapsule, wherein the fragrance is encapsulated by a gelatin-like material. The microencapsulated fragrance was then dry blended with powdered monopersulfate and tested.

TABLE 1

| | | | | | Fragrance Percent Mass | | |
|---|---|---|---|---|---|---|---|
| | | | | | Percent Mass of Fragrance | | |
| Ex./ | | | Fragrance Quality | | | Final (5 days | |
| Comp. | | Fragrance | | Final (5 days of | | of accelerated | Percent |
| Ex. | Fragrance Carrier | Utilized | Initial | accelerated aging) | Initial | aging) | Loss |
| Ex. 1 | Magnesium Sulfate | Aqua Fresh | Good | Good | 0.49% | 0.41% | −16.33% |
| Comp. | Sodium Bisulfate | Aqua Fresh | Fair, Slight | Very strong | 0.54% | 0.50% | −7.41% |
| Ex. 1 | | | Malodor | malodor | | | |
| Comp. | Sodium Acetate | Aqua Fresh | Malodor and | N/A | | | |
| Ex. 2 | | | Copius Fumes | | | | |
| Ex. 3 | Sodium Borate | Aqua Fresh | Good | Malodor | 0.48% | 0.37% | −22.92% |
| Comp. | Magnesium Chloride | Aqua Fresh | Malodor and | N/A | | | |
| Ex. 3 | | | Copius Fumes | | | | |
| Comp. | Sodium Chloride | Aqua Fresh | Malodor and | N/A | | | |
| Ex. 4 | | | Copius Fumes | | | | |
| Ex. 4 | Monopersulfate (no | Colada | Good | Good | 1.03% | 0.91% | −11.65% |
| | carrier) | | | | | | |
| Comp. | Sodium Carbonate | Aqua Fresh | Good | Good | 1.37% | 1.18% | −13.87% |
| Ex. 5 | | | | | | | |
| Comp. | Sodium Carbonate | Colada | Good | Good | 1.48% | 1.40% | −5.41% |
| Ex. 6 | | | | | | | |
| Ex. 5 | Carboxymethylcellulose | Relax 947- | Good | Poor, character | 1.16 | 1.27 | 9.48% |
| | | 024J | | change | | | |
| Ex. 6 | Hydroxypropylcellulose | Relax 947- | Good | OK | 0.95 | 0.94 | −1.05% |
| | | 024J | | | | | |
| Ex. 7 | Polyacrylic acid | Relax 947- | Good | Good | 1.18 | 1.17 | −0.85% |
| | | 024J | | | | | |
| Ex. 8 | Co-polyacrylic acid- | Relax 947- | Good | Poor, character | 1.26 | 1.32 | 4.76% |
| | acrylamide | 024J | | change | | | |
| Ex. 9 | Microencapsulate | Peach (house) | Good | na | na | na | na |

Percent Monopersulfate

| | | | |
|---|---|---|---|
| Ex./Comp. | Initial | Final (Average after 5 days | |
| Ex. | (Average) | of accelerated aging) | Percent Loss |

| Ex. 1 | 40.31% | 40.31% | −0.01% | No Reactivity |
|---|---|---|---|---|
| Comp. Ex. 1 | 39.51% | 36.70% | −7.11% | No Reactivity |
| Comp. Ex. 2 | N/A | | | |
| Ex. 3 | 37.94% | 37.54% | −1.07% | No Reactivity |
| Comp. Ex. 3 | N/A | | | |
| Comp. Ex. 4 | N/A | | | |
| Ex. 4 | 41.20% | 41.78% | 1.39% | No Reactivity |
| Comp. Ex. 5 | 35.77% | 0.37 | 2.47% | Copius heat and gas |
| Comp. Ex. 6 | 36.28% | 0.36 | −1.30% | Copius heat and gas |
| Ex. 5 | 40.4 | 39.8 | −1.49% | none |
| Ex. 6 | 39.7 | 39.8 | 0.25% | none |
| Ex. 7 | 40.1 | 39 | −2.74% | none |
| Ex. 8 | 40.9 | 40.4 | −1.22% | none |
| Ex. 9 | 37.17 | 37.08 | −0.24% | |

The composition of the invention can be used by introducing it into a pool or spa at a dosing rate 1 lb per 1000 gallons of pool water and 1.5 tablespoons per 250 gallons of spa water. The composition is designed to be used in conjunction with the Nature2 Spa Stick in spa applications, as a non-chlorine shock product for the pool and spa, or as a source of pool or spa fragrance.

What is claimed is:

1. A composition for oxidizing organic materials in water, comprising:
(a) an alkali metal monopersulfate;
(b) a fragrance;
wherein the composition is substantially free of carbonate, bicarbonate, and halide, salts, and wherein the composition does not contain a slow dissolving layer.

2. The composition of claim 1, wherein the fragrance is deposited or adhered to particles of the alkali metal monopersulfate.

3. The composition of claim 1, further comprising:
(c) a water-soluble or water-dispersible particulate carrier material for the fragrance.

4. The composition of claim 3, wherein the carrier material does not generate fumes when contacted with water and the alkali metal monopersulfate.

5. The composition of claim 3, wherein the carrier material does not react with, or form species reactive with, the fragrance.

6. The composition of claim 3, wherein the carrier is selected from the group consisting of a water-soluble alkaline earth metal sulfate, a water-soluble alkali metal borate, a water-soluble or water-dispersible organic polymeric material, and combinations thereof.

7. The composition of claim 6, wherein the water-soluble alkaline earth metal sulfate comprises magnesium sulfate.

8. The composition of claim 6, wherein the water-soluble alkali metal borate comprises sodium borate.

9. The composition of claim 6, wherein the water-soluble or water-dispersible organic polymeric material is selected from the group consisting of carboxymethylcellulose, hydroxypropylcellulose, polyacrylic acid, co-polyacrylic acid-acrylamide, and mixtures or blends thereof.
